(19) United States
(12) Patent Application Publication
(10) Pub. No.: US 2017/0310583 A1
(43) Pub. Date: Oct. 26, 2017

(54) SEGMENT ROUTING FOR LOAD BALANCING

(71) Applicant: Cisco Technology, Inc., San Jose, CA (US)

(72) Inventors: Alon Shlomo Bernstein, Monte Sereno, CA (US); Andre Jean-Marie Surcouf, Saint Leu La Foret (FR); William Mark Townsley, Paris (FR)

(21) Appl. No.: 15/216,259

(22) Filed: Jul. 21, 2016

Related U.S. Application Data
(60) Provisional application No. 62/326,628, filed on Apr. 22, 2016.

(51) Int. Cl. H04L 12/721; H04L 12/803; H04L 12/911; H04L 29/12

(52) U.S. Cl. CPC H04L 45/34; H04L 61/6059; H04L 47/125; H04L 47/728

(57) ABSTRACT

Disclosed is segment routing for load balancing. A network path identification device can receive a first service request identifying a first service. The first service request can originate from a first client device. The network path identification device can select, from a Source Routing (SR) list, a first service node to provide the first service and a first network path to reach the first service node. The SR list can include a set of service nodes that provide the service and one or more network paths to reach each service node from the set of service nodes. The network path identification device can then transmit a response message to the first service request. The response message can identify the first service node and the first network path so that the first client device can use the first network path to request the first service from the first service node.

### CROSS REFERENCE TO RELATED APPLICATIONS

This application claims priority to U.S. provisional application No. 62/326,628, filed on Apr. 22, 2016, which is expressly incorporated by reference herein in its entirety

### TECHNICAL FIELD

This disclosure relates in general to the field of computer networks and, more particularly, pertains to segment routing for load balancing.

### BACKGROUND

In modern computer networks, dedicated load balancers are used to balance work across multiple processing nodes, such as computers, Virtual Machines (VMs, etc., so that individual processing nodes are not overloaded or underutilized. While load balancers provide balance, they can also create a bottleneck and require that integration, calibration and configuration. Accordingly, improvements are needed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for segment routing for load balancing. A network path identification device can receive a first service request identifying a first service. The first service request can originate from a first client device. The network path identification device can select, from a Source Routing (SR) list, a first service node to provide the first service and a first network path to reach the first service node. The SR list can include a set of service nodes that provide the service and one or more network paths to reach each service node from the set of service nodes. The network path identification device can then transmit a response message to the first service request. The response message can identify the first service node and the first network path so that the first client device can use the first network path to request the first service from the first service node.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of computing devices and a network in accordance with the invention;

FIG. 2 illustrates another exemplary system configuration of computing devices and a network in accordance with the invention;

FIG. 3 illustrates another exemplary system configuration of computing devices and a network in accordance with the invention;

FIG. 4 illustrates an example method of segment routing for load balancing; and

FIGS. 5A and 5B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for segment routing for load balancing. A network path identification device can be configured to receive service requests from client devices and/or proxy devices operating on behalf of a client device, and select a service node to service the request as well as a network path to reach the service node. The network path can identify a set of nodes in a network that can be traversed to reach the selected service node. The network path identification device can provide a response message including the selected service node and network path. A client device can use the network path to reach the selected service node, which can provide the client with the requested service.

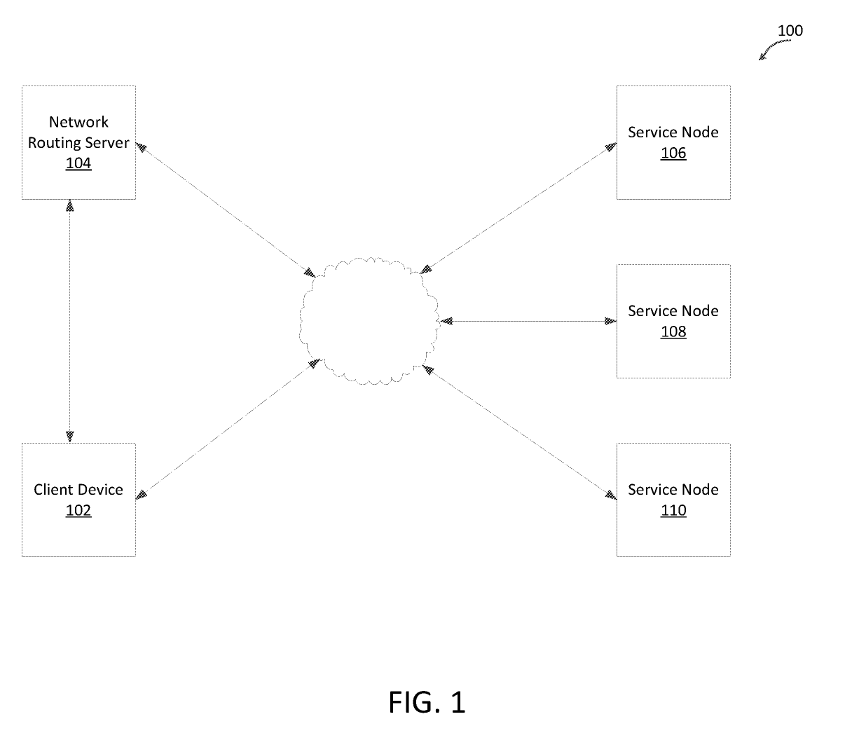

FIG. 1 illustrates an exemplary configuration 100 of computing devices and a network in accordance with the invention. The computing devices can be connected to a communication network and be configured to communicate with each other through use of the communication network. A communication network can be any type of network, including a local area network (“LAN”), such as an intranet, a wide area network (“WAN”), such as the internet, or any combination thereof. Further, a communication network can be a public network, a private network, or a combination thereof. A communication network can also be implemented using any number of communication links associated with one or more service providers, including one or more wired communication links, one or more wireless communication links, or any combination thereof. Additionally, a communication network can be configured to support the transmission of data formatted using any number of protocols.

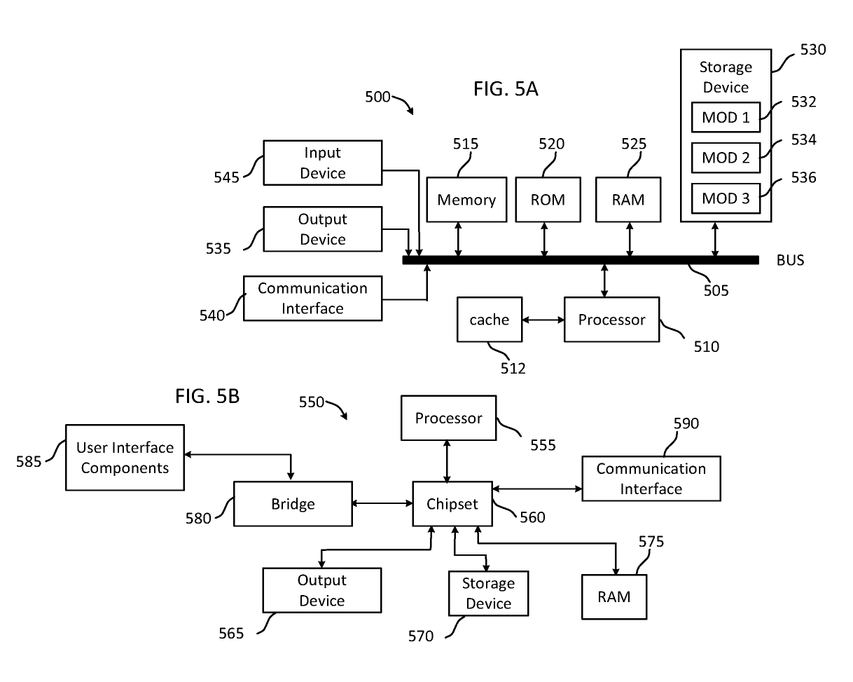

A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 500 of FIGS. 5A and 5B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As shown, system 100 includes 5 computing device: client device 102, network path identification device 104 and service nodes 106, 108 and 110. Although only 5 computing devices are shown, this is just one example and not meant to be limiting. System 100 can include any number of computing devices, including any number of client devices, network path identification devices or service nodes.

Client device 102 can be configured to transmit a service request to network path identification device 104. A service request can be a request that identifies a specified service that can be provided by one of service nodes 106, 108 and 110. In response to receiving a service request, network path identification device 104 can select one of service nodes 106, 108 and 110 to service the request. For example, network path identification device 104 can maintain a Source Routing (SR) list that lists service nodes that can service requests, as well as one or more network paths to reach each service node. A network path can include a set of networking nodes that can be traversed to reach the specified service node. Network path identification device 104 can search the SR list to identify a set of service nodes capable of servicing a specific service request (e.g., service nodes 106, 108 and 110) and select one of the service nodes to service the service request as well as a network path to reach the selected service node.

Network path identification device 104 can select a service node and network path in any know way. For example, network path identification device 104 can rotate selection of service nodes and network paths in a round robin fashion. Additionally, network path identification device 104 can monitor performance of the service nodes and select service nodes based on available bandwidth, resource usage, etc. In this way, network path identification device 104 can balance load amongst the various service nodes as well as the network paths at the network level, without use of a traditional load balancer.

After selecting a service node and network path to service a service request, network path identification device 104 can transmit a response message to client device 102 that identifies the selected service node and network path. For example, the response message can be an MPLS or IPv6 address encoded with the network path to reach the selected service node. Client device 102 can then use the response message (e.g., MPLS or IPv6 address) to communicate with the selected service node.

To provide additional load balancing, in some embodiments, the response message can include data identifying multiple service nodes and/or network paths. For example, network path identification device 104 can select multiple service nodes and network paths and provide them to client device 102 in reply to a service request (e.g., two or more IPv6 addresses). Client device 102 can then alternate between the various service nodes and network paths to receive a specified service. For example, network path identification device 104 can provide client device 102 with two or more IPv6 addresses and client device 102 can alternate use of the IPv6 addresses to request service form a service node.

Additionally, network path identification device 104 can be configured to periodically provide client device 102 with an updated service node and/or network path for a requested service. For example, after initially providing client device 102 with a service node and network path, network path identification device 104 can periodically select an updated service node and/or network path and provide them to client device 102. Client device 102 can then utilize the updated service node and/or network path to access the specified service, thereby balancing load across the available service nodes.

As in some embodiments, network path identification device 104 can monitor performance of the service nodes and network paths and provide client device 102 with an updated service node and/or network path for a specified service based on the monitored performance. For example, network path identification device 104 can determine that an alternate service node and/or network path would be best suited for providing client device 102 with a requested service and transmit data to client device 102 identifying the alternate service node and/or network path, such as an updated IPv6 address.

In some embodiments, client device 102 can be configured to transmit service requests to network path identification device 104 to receive an updated service node and/or network path to provide a service. For example, client device 102 can be configured to periodically transmit service requests to network path identification device 104 to receive an updated service node and/or network path to provide a service. As another example, client device 102 can transmit a service request for an updated service node and/or network path upon detecting network latency with an existing service node and/or network path.

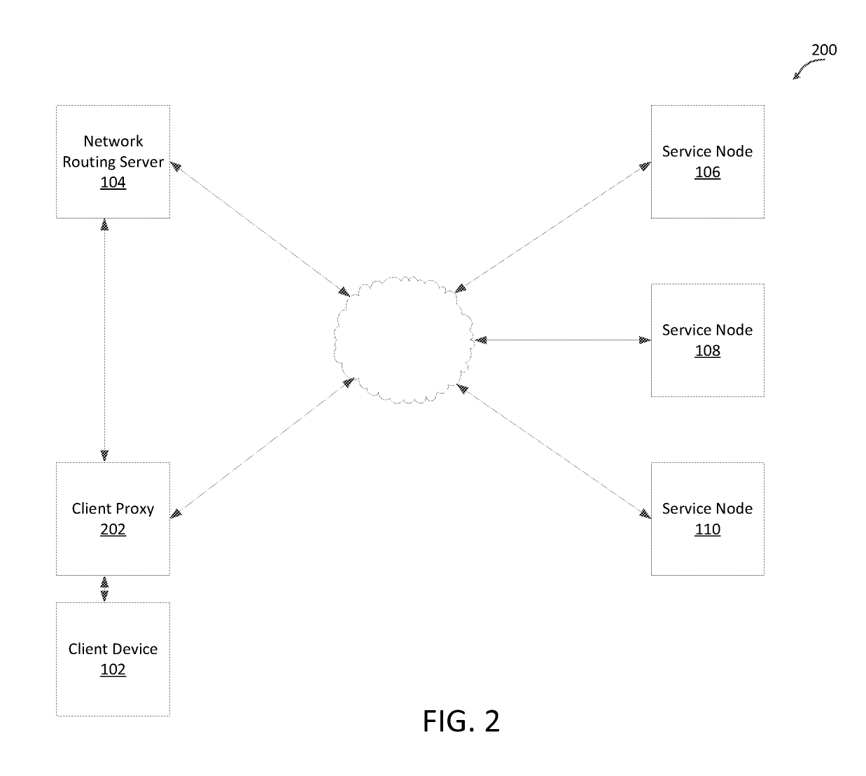

FIG. 2 illustrates another exemplary system configuration of computing devices and a network in accordance with the invention. As shown, system 200 includes client proxy 202 in addition to client device 102, network path identification device 104 and service nodes 106, 108 and 110. Client proxy 202 can be utilized when client device 102 is not an SR capable device. For example, client proxy 202 can be configured to handle communications with network path identification device 104 and service nodes 106, 108 and 110 in place of client device 102. Client proxy 202 can be configured to receive service requests from client device 102, forward the service requests to network path identification device 104 and communicate with service nodes 106, 108 and 110.

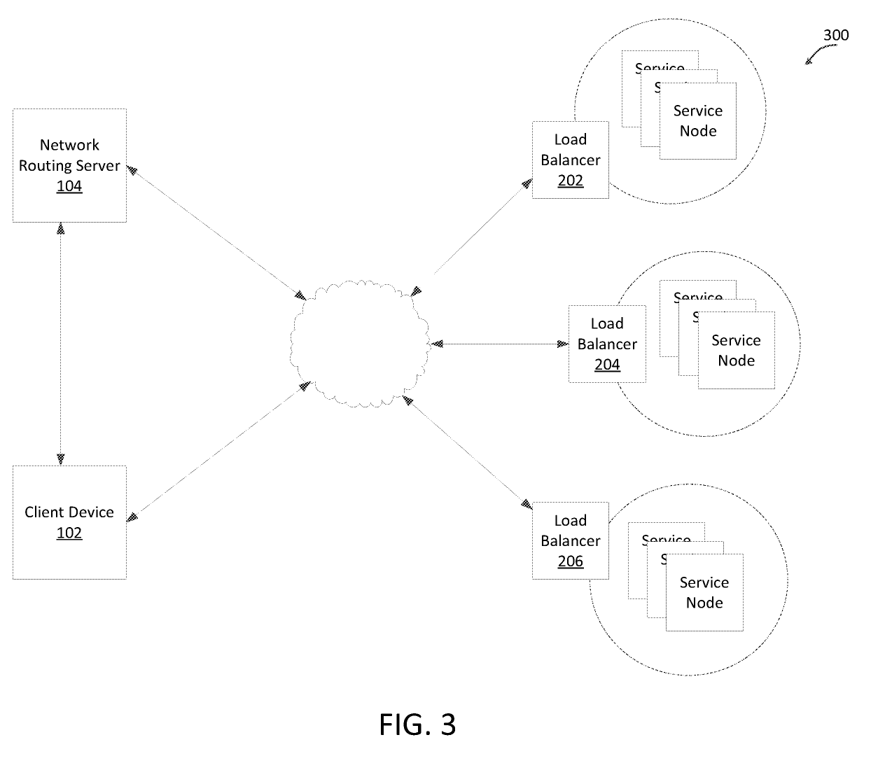

FIG. 3 illustrates another exemplary system configuration of computing devices and a network in accordance with the invention. System 300 can utilize load balancers 202, 204 and 206 to provide multiple layers of load balancing. As shown, load balancers 202, 204 and 206 can each service a set of service nodes. Network routing server 104 can be configured to select one of load balancers 202, 204 and 206 to service a service request received from client device 102, as well as a network path to reach the requested load balancer. Client device 102 can use the network path to reach the selected load balancer, which can then route the request to one of the service nodes associated with the load balancer. In this way, network routing server 104 can balance the load across the load balancers 202, 204 and 206, which can then balance the load across their respective service nodes.

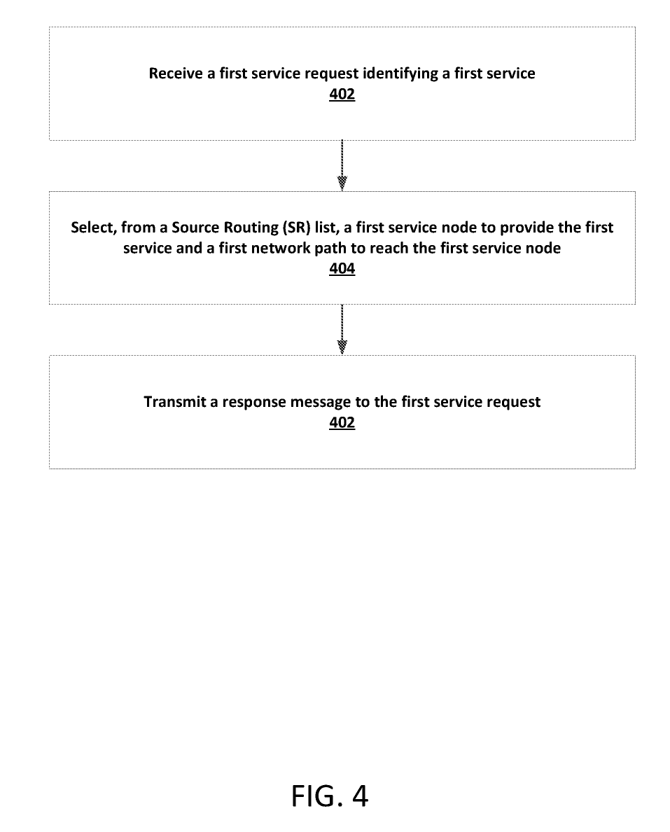

FIG. 4 illustrates an example method of segment routing for load balancing. It should be understood that there can be additional, fewer, or alternative steps performed in similar or alternative orders, or in parallel, within the scope of the various embodiments unless otherwise stated.

At step 402, a network path identification device can receive a first service request identifying a first service. The first service request can originate from a first client device. For example, the first service request can be transmitted to the network path identification device directly from the first client device or, alternatively, via a client proxy device.

At step 404, the network path identification device can select, from a Source Routing (SR) list, a first service node to provide the first service and a first network path to reach the first service node. The SR list can include a set of service nodes that provide the service and one or more network paths to reach each service node from the set of service node. The network path identification device can identify a set of service nodes that can provide the selected service and then select the first service node from the set of service nodes. The network path identification device can then select the first network path from a set of network paths that can be used to reach the first service node.

At step 406, the network path identification device can transmit a response message to the first service request. The response message can identify the first service node and the first network path. For example, the response message can include an IPv6 address that can be used to reach the first service node via the first network path. The first client device can then use the first network path to request the first service from the first service node.

FIGS. 5A and 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 2A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a network path identification device, a first service request identifying a first service, the first service request originating from a first client device;
selecting, from a Source Routing (SR) list, a first service node to provide the first service and a first network path to reach the first service node, wherein the SR list includes a set of service nodes that provide the service and one or more network paths to reach each service node from the set of service node; and
transmitting a response message to the first service request, the response message identifying the first service node and the first network path, wherein the first client device uses the first network path to request the first service from the first service node.

2. The method of claim 1, wherein the first service request was transmitted to the network path identification device from a client proxy in response to the client proxy receiving the first service request from the first client device.

3. The method of claim 1, further comprising:
receiving a second service request identifying the first service;
selecting, from the SR list, the first service node to provide the first service and a second network path to reach the first service node; and
transmitting a second response message, the second response message identifying the first service node and the second network path.

4. The method of claim 1, further comprising:
receiving a second service request identifying the first service;
selecting, from the SR list, a second service node to provide the first service and a second network path to reach the second service node; and
transmitting a second response message, the second response message identifying the second service node and the second network path.

5. The method of claim 4, further comprising:
receiving a third service request identifying the first service;
selecting, from the SR list, the second service node to provide the first service and a third network path to reach the second service node; and
transmitting a third response message, the third response message identifying the second service node and the third network path.

6. The method of claim 1, wherein the first service node is a reverse proxy access device configured route requests to one of a set of service providers configured to provide the first service.

7. The method of claim 1, wherein the response message includes an IPv6 address embedded with an ordered list of networking nodes to reach the first service node.

8. A network path identification device comprising:
one or more computer processors; and
a memory storing instructions that, when executed by the one or more computer processors, cause the network path identification device to:
receive a first service request identifying a first service, the first service request originating from a first client device;
select, from a Source Routing (SR) list, a first service node to provide the first service and a first network path to reach the first service node, wherein the SR list includes a set of service nodes that provide the service and one or more network paths to reach each service node from the set of service node; and
transmit a response message to the first service request, the response message identifying the first service node and the first network path, wherein the first client device uses the first network path to request the first service from the first service node.

9. The network path identification device of claim 8, wherein the first service request was transmitted to the network path identification device from a client proxy in response to the client proxy receiving the first service request from the first client device.

10. The network path identification device of claim 8, wherein the instructions further cause the network path identification device to:
receive a second service request identifying the first service;
select, from the SR list, the first service node to provide the first service and a second network path to reach the first service node; and
transmit a second response message, the second response message identifying the first service node and the second network path.

11. The network path identification device of claim 8, wherein the instructions further cause the network path identification device to:
receive a second service request identifying the first service;
select, from the SR list, a second service node to provide the first service and a second network path to reach the second service node; and
transmit a second response message, the second response message identifying the second service node and the second network path.

12. The network path identification device of claim 11, wherein the instructions further cause the network path identification device to:
receive a third service request identifying the first service;
select, from the SR list, the second service node to provide the first service and a third network path to reach the second service node; and
transmit a third response message, the third response message identifying the second service node and the third network path.

13. The network path identification device of claim 8, wherein the first service node is a reverse proxy access device configured route requests to one of a set of service providers configured to provide the first service.

14. The network path identification device of claim 8, wherein the response message includes an IPv6 address embedded with an ordered list of networking nodes to reach the first service node.

15. A non-transitory computer-readable medium storing instructions that, when executed by network path identification device, cause the network path identification device to:
receive a first service request identifying a first service, the first service request originating from a first client device;
select, from a Source Routing (SR) list, a first service node to provide the first service and a first network path to reach the first service node, wherein the SR list includes a set of service nodes that provide the service and one or more network paths to reach each service node from the set of service node; and
transmit a response message to the first service request, the response message identifying the first service node and the first network path, wherein the first client device uses the first network path to request the first service from the first service node.

16. The non-transitory computer-readable medium of claim 15, wherein the first service request was transmitted to the network path identification device from a client proxy in response to the client proxy receiving the first service request from the first client device.

17. The non-transitory computer-readable medium of claim 15, wherein the instructions further cause the network path identification device to:
receive a second service request identifying the first service;
select, from the SR list, the first service node to provide the first service and a second network path to reach the first service node; and
transmit a second response message, the second response message identifying the first service node and the second network path.

18. The non-transitory computer-readable medium of claim 15, wherein the instructions further cause the network path identification device to:
receive a second service request identifying the first service;
select, from the SR list, a second service node to provide the first service and a second network path to reach the second service node; and
transmit a second response message, the second response message identifying the second service node and the second network path.

19. The non-transitory computer-readable medium of claim 18, wherein the instructions further cause the network path identification device to:
receive a third service request identifying the first service;
select, from the SR list, the second service node to provide the first service and a third network path to reach the second service node; and
transmit a third response message, the third response message identifying the second service node and the third network path.

20. The non-transitory computer-readable medium of claim 15, wherein the first service node is a reverse proxy access device configured route requests to one of a set of service providers configured to provide the first service.
